(19) United States
(12) Patent Application Publication
(10) Pub. No.: US 2017/0184873 A1
(43) Pub. Date: Jun. 29, 2017

(54) NOSE PAD ASSEMBLY AND EYEGLASSES WITH THE SAME

(71) Applicants: HONGFUJIN PRECISION ELECTRONICS (ZHENGZHOU) CO., LTD., Zhengzhou (CN); HON HAI PRECISION INDUSTRY CO., LTD., New Taipei (TW)

(72) Inventors: YU-JIE RONG, Zhengzhou (CN); YUN-ZHI ZHANG, Zhengzhou (CN); ZHEN-WEI LIU, Shenzhen (CN); YA-DONG GAO, Shenzhen (CN)

(21) Appl. No.: 15/249,463

(22) Filed: Aug. 28, 2016

(30) Foreign Application Priority Data
Dec. 24, 2015 (CN) 201510978779.9

(51) Int. Cl. G02C 5/12

(52) U.S. Cl. CPC G02C 5/12

(57) ABSTRACT

Eyeglasses may include a frame and a nose pad assembly fixed on the frame. The nose pad assembly includes a bracket and a receiving member which is used for receiving the bracket. The bracket includes a fixing member and two supporting members, the supporting members are fixed on each end of the fixing member, each supporting member includes an upper part, a middle part, and a lower part, the middle part being twisted into a spiral enables physical adjustment to a person to be carried out with minimal force.

### CROSS-REFERENCE TO RELATED APPLICATIONS

This application claims priority to Chinese Patent Application No. 201510978779.9 filed on Dec. 24, 2015, the contents of which are incorporated by reference herein.

### FIELD

The subject matter herein generally relates to design and construction of eyeglasses, and particularly to eyeglasses and a nose pad assembly of the eyeglasses.

### BACKGROUND

Eyeglasses include a nose pad assembly and a frame, usually, the nose pad assembly and the frame are integrated, or the nose pad assembly is welded on the frame.

### BRIEF DESCRIPTION OF THE DRAWINGS

Many aspects of the disclosure can be better understood with reference to the following drawings. The components in the drawings are not necessarily drawn to scale, the emphasis instead being placed upon clearly illustrating the principles of the disclosure. Moreover, in the drawings, like reference numerals designate corresponding parts throughout the several views.

FIG. 1 is a diagrammatic view of one exemplary embodiment of eyeglasses with a nose pad assembly.

FIG. 2 is an exploded, isometric view of the eyeglasses as in FIG. 1.

FIG. 3 is an exploded, isometric view of the nose pad assembly of the eyeglasses as in FIG. 2.

FIG. 4 is a diagrammatic view of a bracket of the nose pad assembly as in FIG. 3.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the exemplary embodiments described herein. However, it will be understood by those of ordinary skill in the art that the exemplary embodiments described herein can be practiced without these specific details. In other instances, methods, procedures, and components have not been described in detail so as not to obscure the related relevant feature being described. Also, the description is not to be considered as limiting the scope of the exemplary embodiments described herein. The drawings are not necessarily to scale and the proportions of certain parts have been exaggerated to better illustrate details and features of the present disclosure.

The present disclosure, including the accompanying drawings, is illustrated by way of examples and not by way of limitation. Several definitions that apply throughout this disclosure will now be presented. It should be noted that references to “an” or “one” exemplary embodiment in this disclosure are not necessarily to the same exemplary embodiment, and such references mean “at least one”.

Exemplary embodiments of the present disclosure will be described with reference to the accompanying drawings.

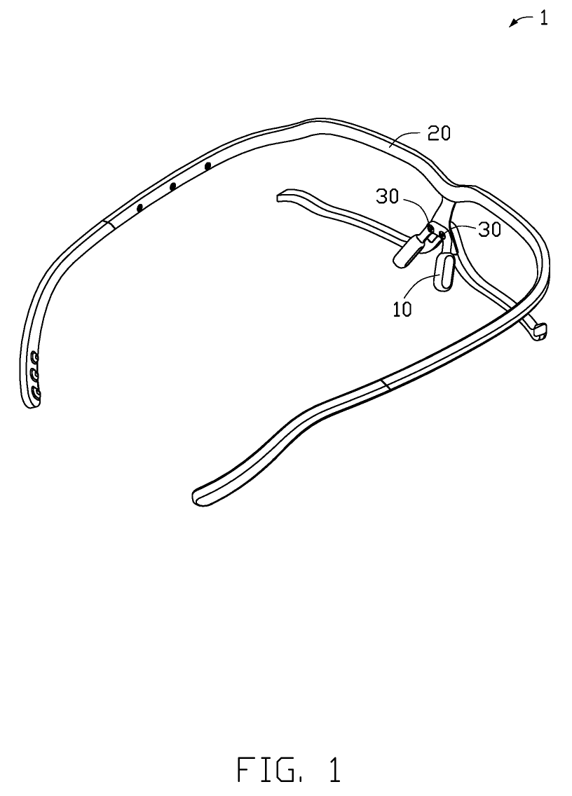

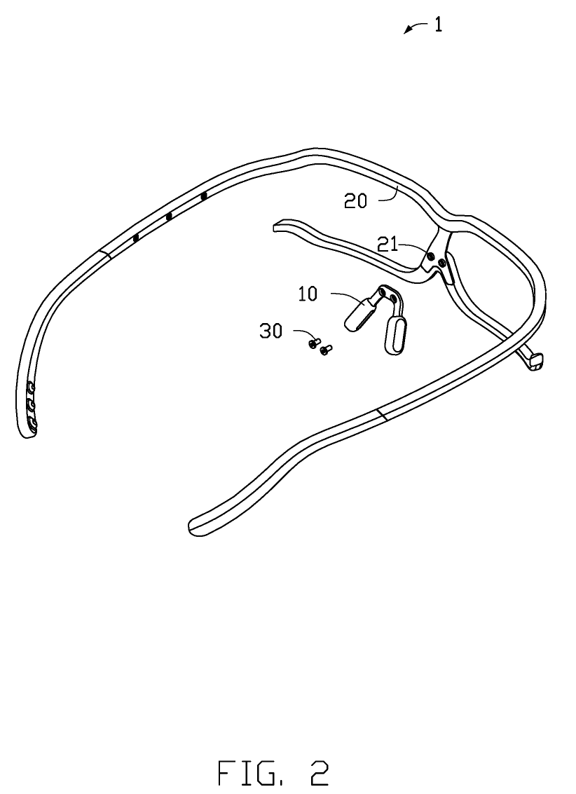

FIG. 1-2 illustrates eyeglasses 1 of one exemplary embodiment. The eyeglasses 1 include a nose pad assembly 10 and a frame 20. The nose pad assembly 10 is fixed on the frame 20. In the illustrated exemplary embodiment, the eyeglasses can be smart eyeglass, myopic eyeglass, presbyopic eyeglass, or sunglass.

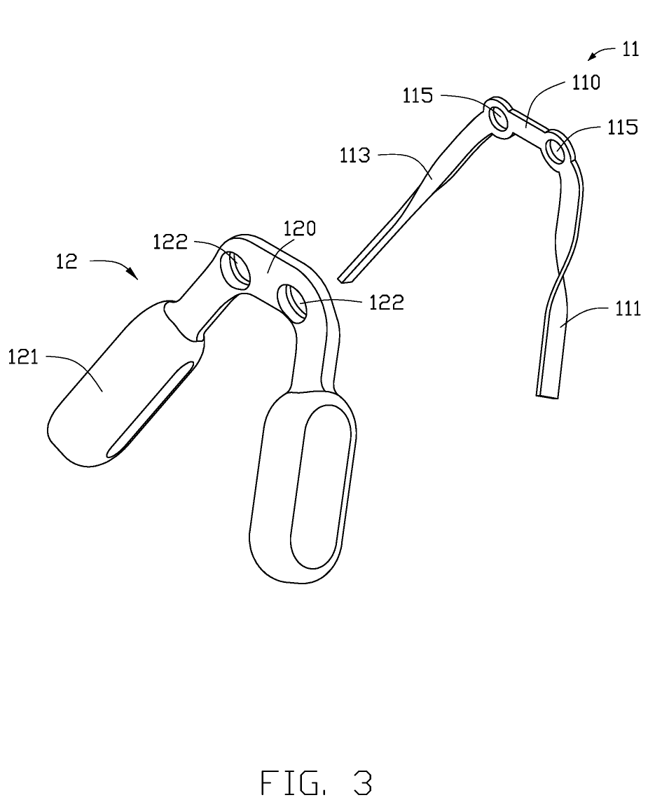

Referring to FIG. 3, the nose pad assembly 10 includes a bracket 11 and a receiving member 12. The bracket 11 and the receiving member 12 both are unibody design. In the illustrated exemplary embodiment, the bracket 11 is made from metal. The bracket 11 is inverted U-shaped. In other embodiments, the bracket 11 can also be arched or inverted V-shaped.

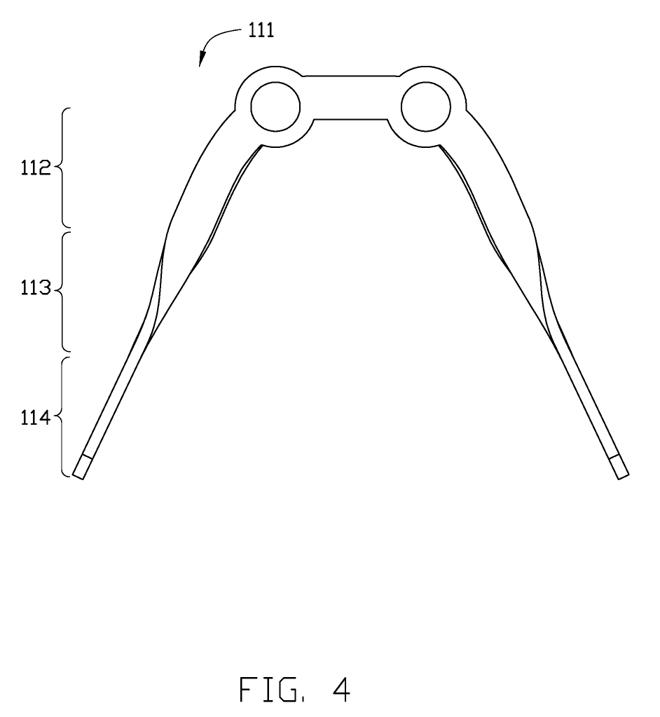

Referring to FIGS. 3-4, the bracket 11 includes a fixing member 110 and two supporting members 111. The supporting members 111 are fixed on each end of the fixing member 110. Each supporting member 111 includes an upper part 112, a middle part 113, and a lower part 114. The lower part 114 is a free end of the supporting member 111. The upper part 112 is connected with an end of the fixing member 110. The middle part 113 is twisted into a spiral shape. The fixing member 110 defines at least one screw hole 115. In the illustrated exemplary embodiment, the fixing member 110 defines two screw holes 115.

The receiving member 12 defines a receiving space which is used for receiving the bracket 11. A shape of the receiving member 12 is the same as the shape of the bracket 11, that is, the receiving member 12 is also inverted U-shaped. The receiving member 12 includes a connecting member 120 and two nose pads 121. The nose pads 121 are fixed on each end of the connecting member 120. The connecting member 120 defines at least one through hole 122 at a position corresponding to the screw hole 115 of the fixing member 110. In the illustrated exemplary embodiment, the connecting member 120 defines two through holes 122. The connecting member 120 receives the fixing member 110 of the bracket 11, the nose pad 121 receives the supporting member 111 of the bracket 11, and the through hole 122 is aligned with the screw hole 115. In the illustrated exemplary embodiment, the receiving member 12 is made from rubber or similar material.

As illustrated in FIG. 2, the eyeglasses 1 further include at least one screw 30 which is used for fastening the nose pad assembly 10. The frame 20 defines at least one screw hole 21. The position of the screw hole 21 corresponds to the position of the through hole 122 and the screw hole 115. The screw 30 is fastened in the screw hole 21 of the frame 20 through the through hole 122 and the screw hole 115.

When a user needs to adjust an optical distance between the eyeglasses 1 and eyes of the user, the user can apply force to move the two nose pads 121. The force can be applied simultaneously on the lower part 114 of the supporting member 111. The shape of the middle part 113 of the supporting member 111 allows only a light force to be sufficient to drive the two supporting members 111 closer together or further away from each other, thereby a distance between the two nose pads 121 is changed, and accordingly the optical distance between the eyeglasses 1 and the eyes of the user is adjusted. In addition, the supporting member 111 can also be driven to rotate easily by the light force, which enables the two nose pads 121 to be adapted to the shape of the user's nose.

In the illustrated exemplary embodiment, a length of the upper part 112 of the supporting member 111 is less than a length of the middle part 113, and a length of the lower part 114 is greater than the length of the middle part 113. Thus, the extent of the force to be applied on the nose pad 121 to achieve a desired fitting is reduced even further, as the lower part 114, the middle part 113 and the upper part 112 can be easily driven to move or deform.

A torque of the middle part 113 is in proportion to the length of the lower part 114, that is, the longer the lower part 114 is, the more easily the middle part 113 deforms, thus, if the length of the lower part 114 is greater than the length of the middle part 113, the user can adjust the distance between the eyeglasses 1 and the eyes more easily. A bending moment of the upper part 112 is in proportion to the length of the upper part 112, that is, the longer the upper part 112 is, the more easily the upper part 112 bends. Thus, if the length of the upper part 112 of the supporting member 111 is less than the length of the middle part 113, the upper part 112 is relatively short and cannot be easily broken, thereby avoiding damage to the bracket 11 when adjusting the distance between the eyeglasses 1 and the eyes of the user.

It is believed that the present embodiments and their advantages will be understood from the foregoing description, and it will be apparent that various changes may be made thereto without departing from the spirit and scope of the disclosure or sacrificing all of its material advantages, the examples hereinbefore described merely being exemplary embodiments of the present disclosure.

What is claimed is:

1. A nose pad assembly comprising:
a bracket; and
a receiving member configured to receive the bracket;
wherein the bracket comprises a fixing member and two supporting members, the supporting members are fixed on each end of the fixing member, each supporting member comprises an upper part, a middle part, and a lower part, the middle part is twisted into a spiral shape.

2. The nose pad assembly according to claim 1, wherein the bracket is inverted U-shaped.

3. The nose pad assembly according to claim 1, wherein the upper part is connected with the end of the fixing member, and a length of the upper part of the supporting members is less than a length of the middle part.

4. The nose pad assembly according to claim 1, wherein the lower part is a free end of the supporting members, and a length of the lower part is greater than a length of the middle part.

5. The nose pad assembly according to claim 1, wherein a shape of the receiving member is the same as the shape of the bracket, the receiving member defines a receiving space which is used for receiving the bracket.

6. The nose pad assembly according to claim 1, wherein the receiving member comprises a connecting member and two nose pads, the nose pads are fixed on each end of the connecting member, the connecting member receives the fixing member of the bracket, and the nose pads receive the supporting members of the bracket.

7. The nose pad assembly according to claim 6, wherein the fixing member defines at least one screw hole, the connecting member defines at least one through hole, and the at least one through hole is aligned with the at least one screw hole.

8. The nose pad assembly according to claim 1, wherein the bracket and the receiving member both are unibody design, the bracket is made from metal, and the receiving member is made from rubber material.

9. Eyeglasses comprising:
a frame; and
a nose pad assembly fixed on the frame;
wherein the nose pad assembly comprises:
a bracket; and
a receiving member configured to receive the bracket;
wherein the bracket comprises a fixing member and two supporting members, the supporting members are fixed on each end of the fixing member, each supporting member comprises an upper part, a middle part, and a lower part, the middle part is twisted into a spiral shape.

10. The eyeglasses according to claim 9, wherein the bracket is inverted U-shaped.

11. The eyeglasses according to claim 9, wherein the upper part is connected with the end of the fixing member, and a length of the upper part of the supporting members is less than a length of the middle part.

12. The eyeglasses according to claim 9, wherein the lower part is a free end of the supporting members, and a length of the lower part is greater than a length of the middle part.

13. The eyeglasses according to claim 9, wherein a shape of the receiving member is the same as the shape of the bracket, the receiving member defines a receiving space which is used for receiving the bracket.

14. The eyeglasses according to claim 9, wherein the receiving member comprises a connecting member and two nose pads, the nose pads are fixed on each end of the connecting member, the connecting member receives the fixing member of the bracket, and the nose pads receive the supporting members of the bracket.

15. The eyeglasses according to claim 14, wherein the fixing member defines at least one screw hole, the connecting member defines at least one through hole, and the at least one through hole is aligned with the at least one screw hole.

16. The eyeglasses according to claim 9, wherein the bracket and the receiving member both are unibody design, the bracket is made from metal, and the receiving member is made from rubber material.

17. The eyeglasses according to claim 9, further comprising:
at least one screw which is used for fastening the nose pad assembly.

18. The eyeglasses according to claim 17, wherein the frame defines at least one screw hole, the at least one screw is fastened in the at least one screw hole of the frame through the bracket and the receiving member of the nose pad assembly.
